(19) United States
(12) Patent Application Publication
(10) Pub. No.: US 2018/0075534 A1
(43) Pub. Date: Mar. 15, 2018

(54) System for Guaranteeing Interest

(71) Applicant: Pierre-Louis de Fouquieres, Dublin (IE)

(72) Inventor: Pierre-Louis de Fouquieres, Dublin (IE)

(21) Appl. No.: 15/701,804

(22) Filed: Sep. 12, 2017

Related U.S. Application Data
(60) Provisional application No. 62/393,848, filed on Sep. 13, 2016.

(51) Int. Cl. G06Q 40/06

(52) U.S. Cl. CPC G06Q 40/06; G06F 17/30283

(57) ABSTRACT

Embodiments of the present invention are a system for recording the ownership of an electronic token and its corresponding interest-bearing instruments (referred to as Notes). The system automatically credits the face value of Notes to their holder's account on the scheduled maturity date, thereby precluding the possibility of default. The method of issuing the Notes is such as to ensure that the total quantity of tokens in existence cannot exceed its pre-determined limit at any future date. The present invention enables a blockchain system to have a risk-free interest-bearing instrument denominated in its token, in a way which is compatible with a pre-determined token supply.

### CROSS REFERENCE TO RELATED APPLICATION

This application claims the benefit of U.S. Provisional Application No. 62393848, filed Sep. 13, 2016.

### STATEMENT REGARDING FEDERALLY SPONSORED RESEARCH AND DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC

Not Applicable

### STATEMENT REGARDING PRIOR DISCLOSURES BY THE INVENTOR

Not Applicable

### FIELD

The present disclosure is in the technical field of information security.

### BACKGROUND OF THE INVENTION

Blockchain technology has been used to offer tokens which aim at being alternative currencies. However, most such tokens do not pay any interest, and none have a mechanism for paying different interest rates depending in particular on the term over which the interest is paid. In major conventional currencies, more value is held through interest-bearing term instruments (that is, debt instruments) denominated in the currency than as the currency itself. A prominent subset of interest-bearing instruments are government treasury bonds, which are theoretically viewed as risk-free. Having a risk-free interest-bearing instrument is indeed an important feature of a currency system. On the other hand, blockchain-based systems do not lend themselves well to having integrated debt instruments. One of the advances offered by blockchain technology is the ability to operate as an autonomous system, but this is not compatible with enforcing the collection of debt. Furthermore, a lot of blockchain tokens aim to preserve the anonymity of their holders, which also undercuts any effort to collect debt from a defaulting party.

Blockchain tokens typically have a pre-determined token supply trajectory, which means both that the quantity of tokens is exactly known at each point in time and also that there is a rigid rule determining this quantity in the future. This is desirable to token holders as it maintains the scarcity value of the token.

### SUMMARY OF THE INVENTION

Embodiments of the present invention are a system for recording the ownership of an electronic token and its corresponding interest-bearing instruments (hereinafter Notes). The system automatically credits the face value of Notes to their holder's account on the scheduled maturity date, thereby precluding the possibility of default. The method of issuing the Notes is such as to ensure that the total quantity of tokens in existence cannot exceed its pre-determined limit at any future date, which ensures the token cannot be debased. In conjunction, these properties uniquely protect holders of Notes against credit risk, as well as loss of value of the token they are denominated in.

Using the present invention enables a blockchain system to have a risk-free interest-bearing instrument denominated in its token, in a way which is compatible with a pre-determined token supply.

### BRIEF DESCRIPTION OF THE DRAWINGS

FIG. 1 describes main execution steps per one cycle of system operation;

FIG. 2 describes the core of the Issuance process;

FIG. 3 describes a data structure for Note purchase instruction;

FIG. 4 is a view of a programmable device for implementing the techniques described herein according to the embodiment;

FIG. 5 describes a data structure to account for Token and Notes ownership;

FIG. 6 describes the structure of the system as a network of programmable devices;

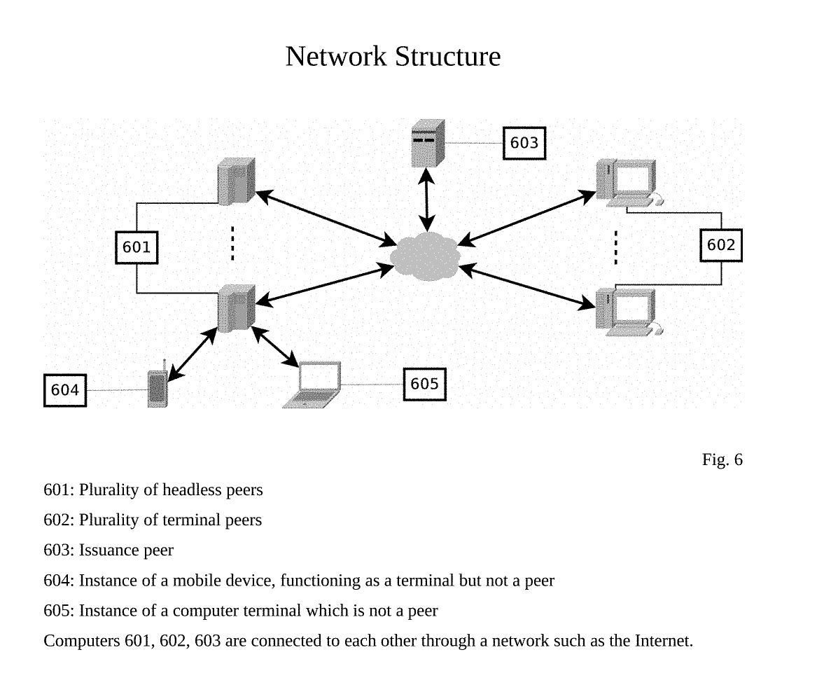

Listings 1-4 are source code in the Python programming language for use in the first embodiment of the invention.

### DETAILED DESCRIPTION OF THE INVENTION

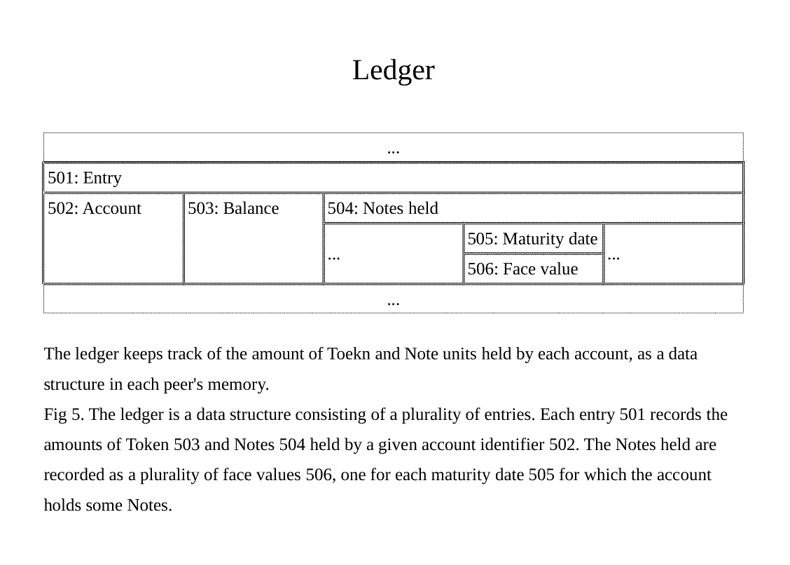

Embodiments of the invention are a system consisting of a database distributed over a plurality of computers. This database keeps track of a ledger data structure, as depicted in FIG. 5, which generally changes in time. Each peer computer 601, 602, 603 has a local instance of the ledger in its memory 402, which its processor 401 is able to alter. When talking about modifying or updating “the ledger” it is meant that the each peer carry out said operation on their local instance. Embodiments of the invention have a mechanism for periodically reaching consensus on the state of the current ledger as tracked by the system, which each peer subsequently uses as its local ledger instance.

The token which is managed by the system is referred to simply as “the Token”. A Note is an asset accounted in the system which transforms, on a specific maturity date, into a specific amount of Token units, referred to as the Note's face value. Since a collection of Notes with the same maturity date is equivalent to a single Note whose face value is the sum of the face values in the collection, for each date the face value of Notes is considered a single unit.

Ownership of Tokens and Notes is divided amongst a plurality of accounts, and this is recorded in the ledger data structure. Each account is characterised by an identifier and a corresponding secret. Computers 602, 604, 605 are terminals which each hold the copy of a plurality of account secrets, with which a terminal can generate instructions for the corresponding account. Embodiments of the invention have a payment instruction type, for transferring Token units to another account, and a purchase instruction type, which attempts to purchase newly issued Notes.

The primary desired physical outcome of the system is for the Token balance to be correctly shown at each terminal, in accordance with the rules defining the nature of Note instruments, and the effect of instructions carried out by all the terminals.

### First Embodiment

In a first embodiment, each account secret is a cryptographic private key, with the corresponding public key as account identifier. The terminals generate instructions by cryptographically signing the instruction parameters.

Each peer is able to broadcast data to the full network of peers, by sending a data packet to the peers to which it has a direct connection (in the form of a TCP connection). The receiving peers will in turn send the packet to those peers to which they have a direct connection, and so on, until the packet has reached every peer.

A proof of stake method is used as a consensus mechanism, with the amount of stake an account has being proportional to its Token holding. This involves each account cryptographically signing a ledger in each period, and the ledger with the highest total stake of its signatures being used as the consensus choice of the system.

The number of Token units in circulation (hereinafter Token supply) on a given day shall be referred to by Z. The term supply limit refers to the maximum number of Token units in circulation which are allowed at a particular point in time, and shall be referred to by M. Prior to any Notes having been issued, it will be the case that the Token supply Z equals M.

In the first embodiment, the supply limit grows at a fixed rate daily, such that its annualised growth rate is of 6% (where a standard year is taken to have 365.2425 days).

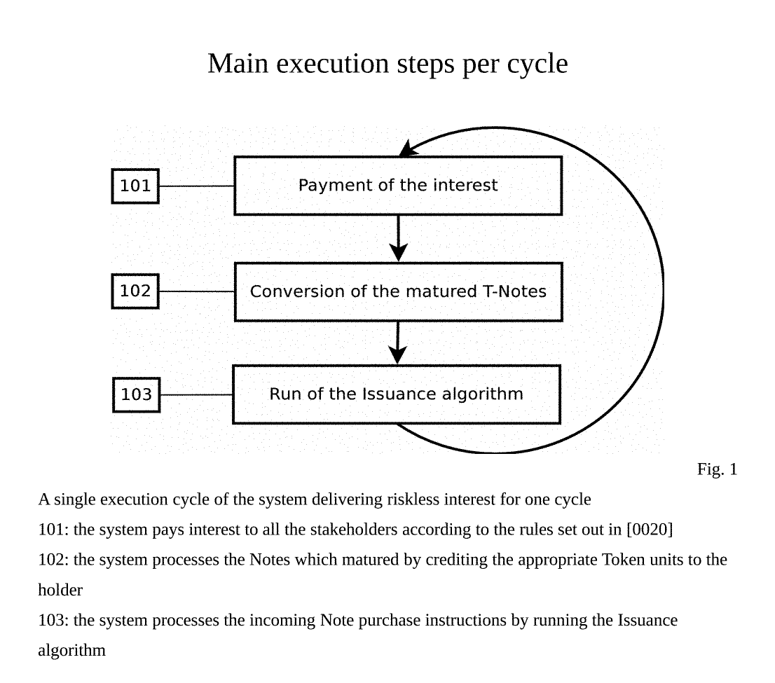

The lifecycle of the system is described in FIG. 1, where the steps 101, 102, 103 occur in succession at midnight on each day. Prior to the first step, the supply limit M must be increased from its value on the previous day, by a multiplicative factor of m as defined in Listing 3.

The first step 101 is the payment of interest. At the end of each day, the system pays interest to each Token holder, such that their balance of Tokens grows by a multiplicative factor of g(Z/M) upon the receipt of interest, where g is the polynomial function as defined in Listing 3. This is done by multiplying the balance 503 within each ledger entry by said factor.

The second step 102 is the conversion of Notes scheduled to mature at the current time into Token units. The ledger is updated to credit each account holding maturing Notes with an amount of Token units equal to the face value of said Notes. All maturing Notes, thereafter having been transformed, are removed from the ledger in the same step 102.

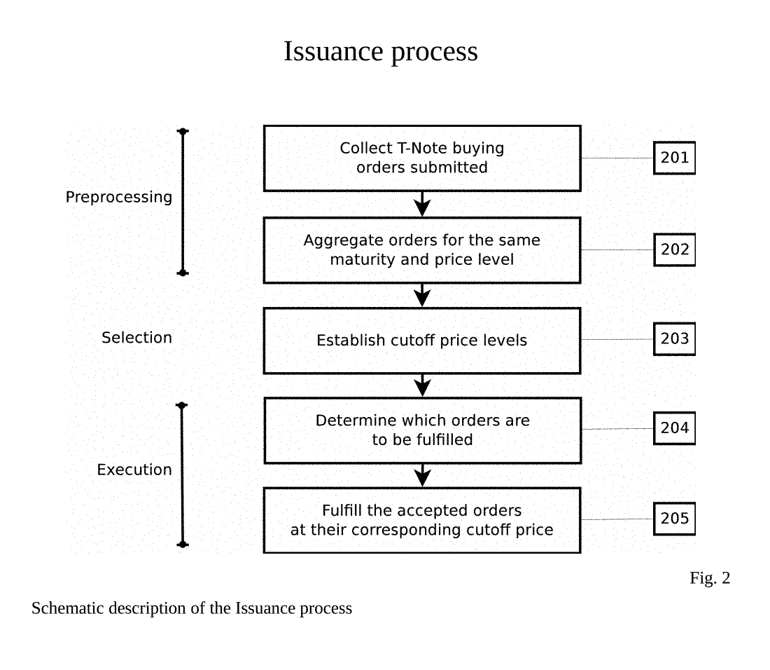

The third step 103 is carrying out an Issuance process described in FIG. 2. The Issuance process and the fulfillment of the successful purchase instructions are executed by a specially designated entity which is represented by a separate peer called the issuance peer.

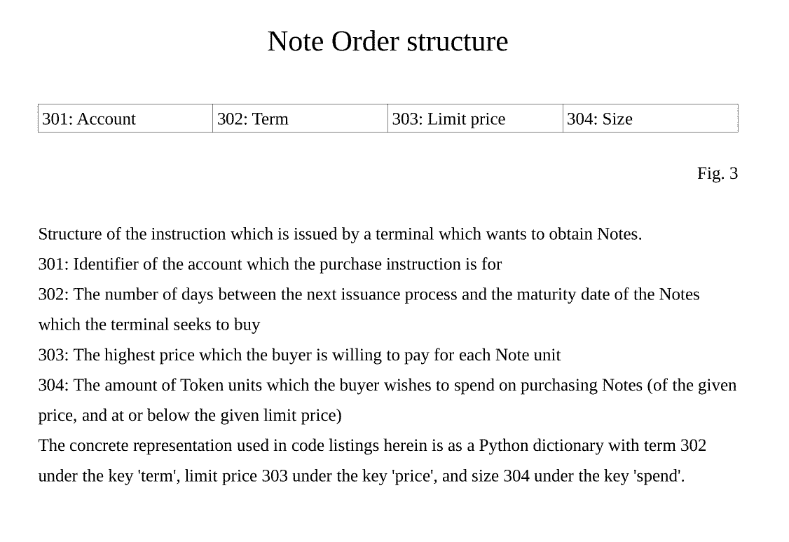

In between Issuance processes, terminals submit to the issuance peer their instructions to purchase Notes in the subsequent Issuance process. Each purchase instruction consists of four pieces of information, as shown in FIG. 3. This set of purchase instructions is thereby available at the outset 201 of the Issuance process.

The purchase instructions are aggregated 202 so as to be usable by the Issuance algorithm. A function called prepare to carry out this step as in the first embodiment is given in Listing 2.

For step 203, the Issuance algorithm is run, in the first embodiment by calling the function solve as part of Listing 3. This function requires the global variables M, Fs, and bids to be set appropriately. M should be set to the current supply limit. Fs should be a list whose entry at index 0 is set to the current Token supply Z, and entries at later indexes equal the total face value of Notes in existence with that term (index 1 for a term of 1 day). bids should be set to the output of step 202, specifically, the return value of the prepare function of Listing 2. If the list Fs is not longer than the list bids by exactly one entry, then either Fs should be extended with zeros, or bids should be extended with Python None values to make this condition satisfied.

The result of the Issuance algorithm is used in 204 to determine the result of each purchase instruction in terms of the face value of Notes received and corresponding Token unit cost. A procedure, named fill, is given in Listing 4 which accepts the return value of the Issuance algorithm function solve, as second argument. The list of Orders should be passed as first argument to function fill, and the return value will be a corresponding list of Order Python dictionaries, augmented with two items, having keys ‘cost’ and ‘notes’. The value corresponding to key ‘cost’ gives the amount of Token units which are to be spent, while the value corresponding to the key ‘notes’ gives the face value of the Notes to be obtained as a result.

The preceding steps of the Issuance process were carried out on the issuance peer, and the output is communicated to all other peers, using a cryptographic signature to verify the source of the output. The final step 205 is to reflect the change in ownership of Token units and Notes for each account for which an purchase instruction was submitted. This processing is carried out independently on each peer.

After the execution of the Issuance process, the system updates Z to reflect the new balance and moves to the next cycle.

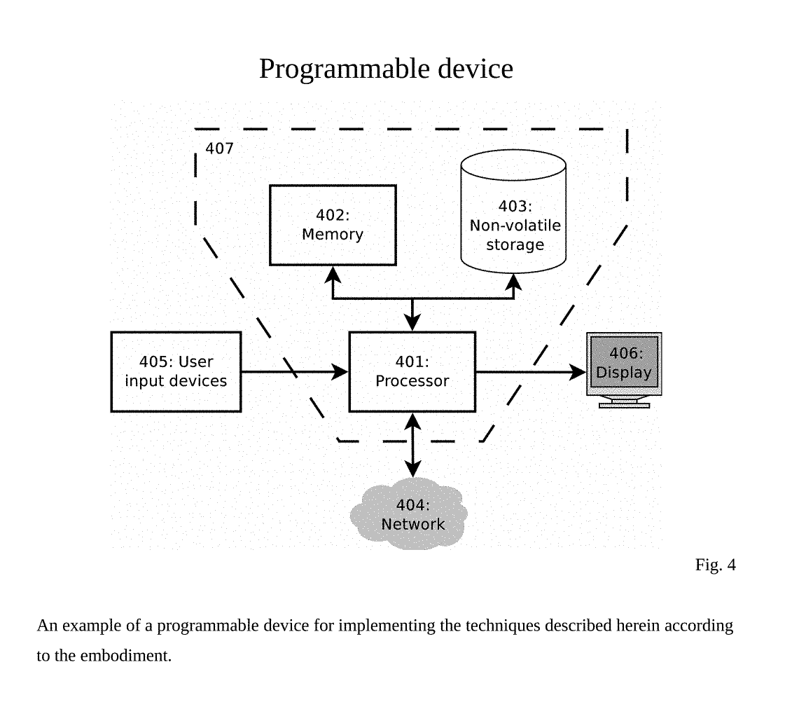

FIG. 4 illustrates an exemplary hardware environment for an apparatus 407, which may be configured as any of machines 601 through to 605. For the purposes of the invention, apparatus 407 may represent practically any computer, computer system, or programmable device e.g., multi-user or single-user computers, desktop computers, portable computers and devices, handheld devices, network devices, mobile phones, etc. Apparatus 407 will hereinafter be referred to as a “computer” although it should be appreciated that the term “apparatus” may also include other suitable programmable electronic devices.

Computer 407 typically includes at least one processor 401 coupled to memory 402. Processor 401 may represent one or more processors (e.g. microprocessors), and memory 402 may represent the random access memory (RAM) devices comprising the main storage of computer 407, as well as any supplemental levels of memory, e.g., cache memories, non-volatile or backup memories (e.g. programmable or flash memories), read-only memories, etc. In addition, memory 402 may be considered to include memory storage physically located elsewhere in computer 407, e.g., any cache memory in a processor 401, as well as any storage capacity used as a virtual memory, e.g., as stored on a mass storage device 403 or another computer coupled to computer 407 via a network 404.

Computer 407 also typically receives a number of inputs and outputs for communicating information externally. For interface with a user or operator, computer 407 typically includes one or more user input devices 405 (e.g., a keyboard, a mouse, a touchpad, a trackball, a keypad, a joystick, a stylus, among others). Computer 407 may also include a display 406 (e.g., a CRT monitor, an LCD display panel, among others). The interface to computer 407 may also be through an external terminal connected directly or remotely to computer 407, or through another computer communicating with computer 407 via a network 404, modem, or other type of communications device.

Computer 407 operates under the control of an operating system, and executes or otherwise relies upon various computer software applications, components, programs, objects, modules, data structures, etc. Computer 407 communicates on the network 404, through a network interface which can be implemented in hardware or software, using a network protocol implemented in the operating system, for example.

In general, the routines executed to implement the embodiments of the invention, whether implemented as part of an operating system or a specific application; component, program, object, module or sequence of instructions will be referred to herein as “computer program code”, or simply “program code”. The computer program code typically comprises one or more instructions that are resident at various times in various memory and storage devices in a computer, and that, when read and executed by one or more processors in a computer, causes that computer to perform the steps necessary to execute steps or elements embodying the various aspects of the invention. Moreover, while the invention has and hereinafter will be described in the context of fully functioning computers and computer systems, those skilled in the art will appreciate that the various embodiments of the invention are capable of being distributed as a program product in a variety of forms, and that the invention applies equally regardless of the particular type of computer readable media used to actually carry out the distribution. Examples of computer readable media include but are not limited to physical, recordable type media such as volatile and non-volatile memory devices, floppy and other removable disks, hard disk drives, optical disks (e.g., CD-ROM's, DVD's, etc.), among others, and transmission type media such as digital and analog communication links.

In addition, various program code described herein may be identified based upon the application or software component within which it is implemented in specific embodiments of the invention. However, it should be appreciated that any particular program nomenclature used herein is merely for convenience, and thus the invention should not be limited to use solely in any specific application identified and/or implied by such nomenclature. Furthermore, given the typically endless number of manners in which computer programs may be organized into routines, procedures, methods, modules, objects, and the like, as well as the various manners in which program functionality may be allocated among various software layers that are resident within a typical computer (e.g., operating systems, libraries, APIs, applications, applets, etc.), it should be appreciated that the invention is not limited to the specific organization and allocation of program functionality described herein.

Those skilled in the art will recognize that the exemplary environment illustrated in FIG. 4 is not intended to limit the present invention. Indeed, those skilled in the art will recognize that other alternative hardware and/or software environments may be used without departing from the scope of the invention.

### Embodiment Alternatives

In an alternative embodiment, interest on Token holdings is awarded to accounts only in proportion to the number of periods within the day for which they have signed the ledger which became the consensus choice of the system. In a further alternative embodiment, ownership of Notes counts towards the stake of each account.

In an alternative embodiment, there is an additional instruction for one account to transfer Notes into another account. An exchange service operates enabling terminals to buy or sell Notes for Token units, ensuring that the payment instruction from the buyer account is processed simultaneously with the transfer instruction from the seller account.

In an inferior embodiment, the ledger of Token and Notes ownership is held in a centralized database. In a preferred embodiment, this ledger is held by a distributed database. In certain embodiments, the ledger is replicated across the system, such that each peer has a copy. In other embodiments, the ledger is segmented into subsets of accounts, with each segment replicated across a subset of peers.

The underlying token can take various forms, for example electronic money, equity in a corporation, or customer reward points (such as airline miles), without departing from the scope of the invention.

In alternative embodiments, the Issuance algorithm can be one which, for certain sets of Orders, returns price levels different to those returned by the solve function of Listing 3.

In alternative embodiments, the Issuance algorithm is run independently on each peer so that there is no distinguished issuance peer.

In alternative embodiments, a Note is defined as an instrument which grants the holder periodic payments in the Token, in addition and up to the final payment of the face value. Such coupon payments are for example at a fixed rate, or a variable rate equal to the interest rate on Tokens.

In alternative embodiments, the frequency of possible maturities for Note instruments is different from a single day, with Notes maturing for example on the hour, or on midnight of the last day of each month. Moreover, the Issuance process happens at times different from possible maturity dates, for instance in sufficiently rapid succession that it is effectively continuous.

In an inferior embodiment, the requirement that the token supply be predetermined is weakened such that the token supply is only constrained by one or more external factors.

Listing 1: Imports common to all code listings
Shared imports

from numpy import *
from numpy.polynomial import Polynomial
from numpy.polynomial import polynomial as poly
from scipy.optimize import newton
from copy import deepcopy
from pandas import DataFrame

Suggested versions for software package dependencies are as follows: Python 2.7.9, NumPy 1.8.1, SciPy 0.13.3, Pandas 0.15.0

Listing 2
Preprocessing function

```
def prepare(orders):
  bids = [ ]
  for order in orders:
    idx = order[′term′] − 1
    if idx >= len(bids):
      bids.extend([None] * (idx − len(bids) + 1))
    book = bids[idx]
    if book is None:
      book = {order[′price′]: order[′spend′]}
    else:
      book[order[′price′]] = book.get(order[′price′], 0) + order[′spend′]
    bids[idx] = book
  bids = [DataFrame(book.items( ), columns=[′price′, ′spend′])
        if book is not None else None for book in bids]
  for book in bids:
    if book is not None:
      book.sort(′price′, ascending=False, inplace=True)
      book[′face′] = book[′spend′].cumsum( ) / book[′price′]
  return bids
```

Taken as input is a Python list of Orders, as described in FIG. 3.

Listing 3
Issuance algorithm

```
yeardays = 365,2425
m = 1,06**(1/yeardays)
r = Polynomial([8.0932526635546509e−05, 1.2892273741460541e−05,
0.00021650674409157131])
g = Polynomial([1.0000809325266355, 6.4461368707302704e−06,
7.2168914697190431e−05])
def bisect(f, b, c, scale=1):
  tol = scale * 1e−12
  while abs(float(b) − float(c)) > tol:
    m = (float(b) + float(c)) / 2
    a = f(m)
    if a.gap( ) < 0:
      b = a
    else:
      c = a
  return b, c
class Excess(Exception): pass
gx = g * poly.polyx
class Issuance( );
  def__init__(self):
    D = len(Fs) − 1
    self.Is = full(D+1, nan)
    self.Is[0] = 0
    self.price = full(D, nan)
    self.z = 1
    self.s = D
  def step(self):
    F = Fs[self.s] + self.Is[self.s]
    rhs = m * self.z − F / M / m** self.s-1)
    if rhs < 0:
      raise Excess
    self.z = newton(gx − rhs, rhs, gx.deriv( ))
    self.s −= 1
  def complete(self, price):
    try:
      for s in range(self.s, 0, −1):
        self.price[s-1]= price
        if bids[s-1]is None:
          self.Is[s] = 0
        else:
          book = bids[s-1].iloc[::−1]
          bid = book.iloc[min(book[′price′].searchsorted(price)[0],
len(book)−1)]
          cost = bid[′face′] * bid[′price′]
          self.Is[0] −= cost
          self.Is[s] = cost / price
        self.step( )
        price = (1 + r(self.z)) * price
    except Excess:
      pass
  def upto(self, d):
    new = Issuance( )
    new.Is[d+1:] = self.Is[d+1:]
    new.price[d:] = self.price[d:]
    new.Is[0] = −dot(new.Is[d+1:], new.price[d:])
    while not isnan(new.Is[new.s]):
      new.step( )
    return new
  def resume(self, face):
    book = bids[self.s-1]
    idx = book[′face′].searchsorted(face)[0]
    if idx < len(book):
      bid = book.iloc[idx]
      cost = bid[′face′] * bid[′price′] − \
        min((bid[′face′] − face) * bid[′price′], bid[′spend′])
    else:
      bid = book.iloc[−1]
      cost = bid[′face′] * bid[′price′]
    price = cost / face
    self.Is[0] −= cost
    self.Is[self.s] = face
    self.step( )
    price = (1 + r(self.z)) * price
    self.complete(price)
  def gap(self):
    if self.s != 0:
      return −inf
    if self.Is[0] == 0:
      return 0
    return self.z * M − (Fs[0] + self.Is[0])
  def __float__(self):
    return self .x
def solve( );
  assert len(bids) == len(Fs) − 1, ″Mismatched state″
  def byPrice(p):
    a = Issuance( )
    a.x = p
    a.complete(p)
    return a
  b, c = bisect(byPrice, 0, 1)
  assert Fs[0] + b.Is[0] >= 0, ″Invalid bids″
  while abs(c.gap( )) > 1e−3:
    split = where(abs(b.Is − c.Is) > 1e−1)[0][−1]
    base = b.upto(split)
  def byFace(f):
    a = deepcopy(base)
    a.x = f
    a.resume(f)
    return a
  for edge in[b, c]:
    edge.x = edge.Is[split]
  b, c = bisect(byFace, b, c, M)
return c
```

Listing 4
Post-processing function

```
def fill(orders, solution):
  edge = [ ]
  for book, face in zip(bids, solution.Is[1:]):
    cutoff = 0
    part = 1
    if book is not None:
      idx = book[′face′].searchsorted(face)[0]
      if idx < len(book):
        bid = book.iloc[idx]
        cutoff = bid[′price′]
        part = 1 − min((bid[′face′] − face) * bid[′price′] / bid[′spend′], 1)
    edge.append((cutoff, part))
  for order in orders:
    cutoff, part = edge[order[′term′] − 1]
    if order[′price′] > cutoff:
      order[′cost′] = order[′spend′]
    elif order[′price′] == cutoff:
      order[′cost′] = order[′spend′] * part
    else:
      order[′cost′] = 0
    order[′notes′] = order[′cost′] / solution.price[order[′term′] − 1
  return orders
```

What is claimed is:

1. A distributed database which operates over a network of computer systems, such that:
the database holds a ledger, assigning to each account identifier of the system a balance, this balance defining the number of tokens of the system which the account holds;
account holders can issue a Note purchase order to the database, consisting of a term, amount and limit price;
the database is able to process a plurality of Note purchase orders and select one or more such orders to execute, whereby for each said order the corresponding account is debited a balance no greater than the order's amount, and credited Notes of the order's term of a quantity corresponding to a price no greater than the order's limit price;
at such time as any amount of Notes held by an account reaches its maturity, the database automatically credits the account with a balance equal to the amount of Notes;
a rule is given for the total number of tokens, this predetermined number of tokens is not exceeded irrespective of the set of purchase orders issued by accounts through time, and this number of tokens is reached in case no account holds any Notes.
